(19) United States
(12) Patent Application Publication
(10) Pub. No.: US 2025/0187465 A1
(43) Pub. Date: Jun. 12, 2025

(54) APPARATUS FOR CONTROLLING VEHICLE AND METHOD THEREOF

(71) Applicants: Hyundai Motor Company, Seoul (KR); Kia Corporation, Seoul (KR)

(72) Inventors: Ho Sun Jang, Suwon-si (KR); Joon Ha Hwang, Sokcho-si (KR); Jae Sang Lim, Suwon-si (KR); Jin Wook Kang, Gunpo-si (KR)

(21) Appl. No.: 18/768,478

(22) Filed: Jul. 10, 2024

(30) Foreign Application Priority Data
Dec. 7, 2023 (KR) 10-2023-0177103

(51) Int. Cl. B60L 53/14; B60L 58/12

(52) U.S. Cl. CPC B60L 53/14; B60L 58/12; B60L 2240/429

(57) ABSTRACT

A vehicle control apparatus may include a first battery, a second battery, a sensor device, a memory, and a control device. The vehicle control apparatus may drive, based on the first battery, a driving motor, may charge, based on the second battery, the first battery if identifying a trigger signal regarding on-drive-charge (ODC) using the second battery while performing driving control of a host vehicle through the driving motor, may measure, based on the sensor device, a mean value of three-phase currents, and a difference between a maximum value and a minimum value of each of the three-phase currents of the driving motor, and may apply duty compensation to an element corresponding to at least one of the three-phase currents based on the difference and the mean value.

### CROSS-REFERENCE TO RELATED APPLICATIONS

This application claims the benefit of priority to Korean Patent Application No. 10-2023-0177103, filed in the Korean Intellectual Property Office on Dec. 7, 2023, the entire contents of which are incorporated herein by reference.

### TECHNICAL FIELD

The present disclosure relates to a vehicle control apparatus and a method thereof.

### BACKGROUND

With the development of a technology, various components inside a vehicle may be operatively connected to each other. In particular, efficient battery utilization is becoming increasingly important as the number of vehicles driven based on electrical energy gradually expands.

For example, to maximize a driving distance, it may be required to install a battery with a great capacity. However, because there is a limit to a mounting space within the vehicle, a method of increasing only the size of the battery includes limitations.

To overcome the limitations, a charging system that charges a main battery, based on an auxiliary battery, is being developed. For example, a vehicle control apparatus may deliver power from the auxiliary battery to the main battery, thereby improving the driving performance of the vehicle. Such systems may be referred to as on drive charging (ODC).

However, in a process of delivering a current between a plurality of batteries, an imbalance may occur in at least part of currents (or three-phase currents) delivered from the main battery to the driving device (or the driving motor). For example, due to an impedance difference between a DC current delivered from the auxiliary battery to the main battery and an AC current applied from the main battery to the driving device, the three-phase imbalance may occur. Such issues may be referred to as a three-phase imbalance. Such imbalance may adversely affect the output performance and efficiency of a driving system, and even cause harmonics while a host vehicle is driving, resulting in noise, vibration, and an uncomfortable driving experience.

### SUMMARY

The present disclosure relates to a vehicle control apparatus and a method thereof, and more specifically, relates to a technology for compensating for the three-phase imbalance of a driving device in a process of driving a host vehicle based on at least one battery.

Some embodiments of the present disclosure can solve the above-mentioned problems occurring in the prior art while advantages achieved by the prior art are maintained intact.

An embodiment of the present disclosure can provide a vehicle control apparatus that controls a phase-current imbalance to be minimized while charging a first battery, based on a second battery (e.g., an auxiliary battery), if a trigger signal is identified while driving a driving motor, based on the first battery (e.g., the main battery).

An embodiment of the present disclosure can provide a vehicle control apparatus that applies, to at least one element (e.g., a switch), the duty compensation calculated based on a mean value of three-phase currents acting on the driving motor, and a comparison result between the maximum value and the minimum value of each of three-phase currents.

An embodiment of the present disclosure can provide a vehicle control apparatus that increases, based on applying duty compensation to at least one switch, an operating time of a switch and generates a compensation voltage, and increases the magnitude of a current in a phase corresponding to the corresponding switch among three-phase currents.

An embodiment of the present disclosure can provide a vehicle control apparatus that blocks, based on an additional switch, a current output from a second battery before a trigger signal is identified, thereby preventing a conflict between currents output from the first and second batteries.

Technical problems to be solved by some embodiments of the present disclosure are not limited to the aforementioned problems, and other technical problems not mentioned herein can be solved by some embodiments of the present disclosure, as can be understood from the following description by those skilled in the art to which the present disclosure pertains.

According to an embodiment of the present disclosure, a vehicle control apparatus may include a first battery, a second battery, a sensor device, a memory that stores instructions, and a control device operatively connected to the first battery, the second battery, the sensor device, and the memory. For example, if executed by the control device, the instructions may cause the vehicle control apparatus to drive, based on the first battery, a driving motor, to charge, based on the second battery, the first battery if identifying a trigger signal regarding on-drive-charge (ODC) using the second battery while performing driving control of a host vehicle through the driving motor, to measure, based on the sensor device, a mean value of three-phase currents, and a difference between a maximum value and a minimum value of each of the three-phase currents of the driving motor, and to apply duty compensation to an element corresponding to at least one of the three-phase currents based on the difference and the mean value.

According to an embodiment, if executed by the control device, the instructions may cause the vehicle control apparatus to block, based on an additional switch operatively connected to the second battery, a current output from the second battery before identifying the trigger signal.

According to an embodiment, if executed by the control device, the instructions may cause the vehicle control apparatus to identify, based on the sensor device, a first state of charge (SoC) of the first battery and a second SoC of the second battery, and to determine that the trigger signal is identified, if a ratio between the first SoC and the second SoC is outside a specified range.

According to an embodiment, if executed by the control device, the instructions may cause the vehicle control apparatus to compare, based on the sensor device, the mean value of the three-phase currents, with a neutral current of a transfer switch placed in an electrical path between the driving motor and the second battery, and to measure the difference between the maximum value and the minimum value of each of the three-phase currents if the mean value is not the same as the neutral current.

According to an embodiment, if executed by the control device, the instructions may cause the vehicle control apparatus to apply the duty compensation to a first element corresponding to a first phase, through which a first phase current flows, if the greatest value of the difference is identified as being greater than or equal to a first difference between a first maximum value and a second minimum value of the first phase current.

According to an embodiment, the first element includes a first switch module corresponding to the first phase and placed in an electrical path between the first battery and the driving motor.

According to an embodiment, if executed by the control device, the instructions may cause the vehicle control apparatus to calculate the duty compensation so as to be proportional to a magnitude of a difference between the first difference and the greatest value.

According to an embodiment, if executed by the control device, the instructions may cause the vehicle control apparatus to increase, based on applying the duty compensation to the first element, an operating time of the first element.

According to an embodiment of the present disclosure, a vehicle control method may include driving, based on a first battery, a driving motor by a control device, charging, based on a second battery, the first battery by the control device if identifying a trigger signal regarding ODC using the second battery while performing driving control of a host vehicle through the driving motor, measuring, based on a sensor device, a mean value of three-phase currents, and a difference between a maximum value and a minimum value of each of the three-phase currents of the driving motor by the control device, and applying, by the control device, duty compensation to an element corresponding to at least one of the three-phase currents based on the difference and the mean value.

According to an embodiment, the vehicle control method may further include blocking, based on an additional switch operatively connected to the second battery, a current output from the second battery by the control device before identifying the trigger signal.

According to an embodiment, the vehicle control method may further include identifying, based on the sensor device, a first SoC of the first battery and a second SoC of the second battery by the control device, and determining, by the control device, that the trigger signal is identified, if a ratio between the first SoC and the second SoC is outside a specified range.

According to an embodiment, the vehicle control method may further include comparing, based on the sensor device, the mean value of the three-phase currents, with a neutral current of a transfer switch placed in an electrical path between the driving motor and the second battery by the control device, and measuring, by the control device, the difference between the maximum value and the minimum value of each of the three-phase currents if the mean value is not the same as the neutral current.

According to an embodiment, the vehicle control method may further include applying, by the control device, the duty compensation to a first element corresponding to a first phase, through which a first phase current flows, if the greatest value of the difference is identified as being greater than or equal to a first difference between a first maximum value and a second minimum value of the first phase current.

According to an embodiment, the first element includes a first switch module corresponding to the first phase and placed in an electrical path between the first battery and the driving motor.

According to an embodiment, the vehicle control method may further include calculating, by the control device, the duty compensation so as to be proportional to a magnitude of a difference between the first difference and the greatest value.

According to an embodiment of the present disclosure, in a computer-readable recording medium including a program for executing a vehicle control method, the vehicle control method may include driving, based on a first battery, a driving motor by a control device, charging, based on a second battery, the first battery by the control device if identifying a trigger signal regarding ODC using the second battery while performing driving control of a host vehicle through the driving motor, measuring, based on a sensor device, a mean value of three-phase currents, and a difference between a maximum value and a minimum value of each of the three-phase currents of the driving motor by the control device, and applying, by the control device, duty compensation to an element corresponding to at least one of the three-phase currents based on the difference and the mean value.

According to an embodiment, the vehicle control method may further include blocking, based on an additional switch operatively connected to the second battery, a current output from the second battery by the control device before identifying the trigger signal.

According to an embodiment, the vehicle control method may further include identifying, based on the sensor device, a first SoC of the first battery and a second SoC of the second battery by the control device, and determining, by the control device, that the trigger signal is identified, if a ratio between the first SoC and the second SoC is outside a specified range.

According to an embodiment, the vehicle control method may further include comparing, based on the sensor device, the mean value of the three-phase currents, with a neutral current of a transfer switch placed in an electrical path between the driving motor and the second battery by the control device, and measuring, by the control device, the difference between the maximum value and the minimum value of each of the three-phase currents if the mean value is not the same as the neutral current.

According to an embodiment, the vehicle control method may further include applying, by the control device, the duty compensation to a first element corresponding to a first phase, through which a first phase current flows, if the greatest value of the difference is identified as being greater than or equal to a first difference between a first maximum value and a second minimum value of the first phase current.

### BRIEF DESCRIPTION OF THE DRAWINGS

The above and other features and advantages of the present disclosure can be more apparent from the following detailed description taken in conjunction with the accompanying drawings, in which:

FIG. 1 is a block diagram showing components of a vehicle control apparatus, according to an embodiment of the present disclosure;

FIG. 2 is a circuit diagram showing components of a vehicle control apparatus, according to an embodiment of the present disclosure;

FIG. 3 is a diagram conceptually illustrating a circuit diagram illustrating an algorithm, in which a vehicle control apparatus applies duty compensation, according to an embodiment of the present disclosure;

FIG. 4 is a flowchart of a vehicle control method, according to an embodiment of the present disclosure;

FIG. 5 is a flowchart of a vehicle control method, according to an embodiment of the present disclosure; and

FIG. 6 shows a computing system related to a vehicle control apparatus or vehicle control method, according to an embodiment of the present disclosure.

With regard to the descriptions of drawings, same or similar components will be marked by the same or similar reference signs.

### DETAILED DESCRIPTION OF ILLUSTRATIVE EMBODIMENTS

Hereinafter, some example embodiments of the present disclosure will be described in detail with reference to the accompanying drawings. In adding reference numerals to components of each drawing, it can be noted that the same components include the same reference numerals, although they are indicated on another drawing. Furthermore, in describing the example embodiments of the present disclosure, detailed descriptions associated with well-known functions or configurations can be omitted if they may make subject matters of the present disclosure unnecessarily obscure.

In describing elements of an embodiment of the present disclosure, the terms “first”, “second”, “A”, “B”, “(a)”, “(b)”, and the like, may be used herein. Such terms can be used merely to distinguish one element from another element, but do not necessarily limit the corresponding elements irrespective of the nature, order, or priority of the corresponding elements. Furthermore, unless otherwise defined, terms including technical and scientific terms used herein can be interpreted as is customary in the art to which the present disclosure belongs. It can be understood that terms used herein can be interpreted as including a meaning that is consistent with their meaning in the context of the present disclosure and the relevant art.

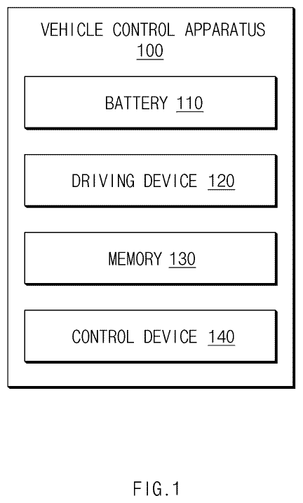

Hereinafter, various example embodiments of the present disclosure will be described in detail with reference to FIGS. 1 to 6.

FIG. 1 is a block diagram showing components of a vehicle control apparatus, according to an embodiment of the present disclosure.

According to an embodiment, a vehicle control apparatus 100 may include at least one of a battery 110, a driving device 120, a memory 130, or a control device 140, or any combination thereof, any combination of or all of which may be in plural or may include plural components thereof. The configuration of the vehicle control apparatus 100 shown in FIG. 1 is an example, and embodiments of the present disclosure are not limited thereto. For example, the vehicle control apparatus 100 may further include components not shown in FIG. 1 (e.g., at least one of a driving device, an input device, an interface device, a communication device, or a notification device, or any combination thereof, any combination of or all of which may be in plural or may include plural components thereof).

According to an embodiment, the battery 110 may include at least one battery that delivers a current (or power) to a driving motor for driving control of the host vehicle.

For example, the battery 110 may include a first battery and a second battery.

The first battery may be, for example, a main battery. In other words, the first battery may include a main battery that includes a greater capacity than the second battery and mainly delivers a current to the drive motor.

The second battery may be, for example, an auxiliary battery. In other words, the second battery may include an auxiliary battery that includes a smaller capacity than the first battery and stores a current for charging the first battery.

The second battery may, additionally or alternatively, for example, deliver a current to the driving motor for driving control of the host vehicle.

For example, the battery 110 may be electrically connected to at least one circuit element.

For example, the first battery may be electrically connected to the driving motor through an inverter.

The inverter may include, for example, at least one switch electrically connected to the driving motor.

For example, the inverter may include a first switch and a fourth switch connected to a first phase, a second switch and a fifth switch connected to a second phase, and a third switch and a sixth switch connected to a third phase from among three phases included in the driving motor.

The inverter may include, for example, at least one current sensor and a temperature sensor. For example, the control device 140 may identify, based on the current sensor and/or the temperature sensor, the temperature of the inverter or the magnitude of a current flowing in an electrical path between the inverter and the driving motor in real time.

For example, the second battery may be electrically connected to the driving motor through at least one of at least one relay, at least one switch, or a capacitor, or any combination thereof.

For example, the at least one relay may include a first relay and a second relay, which are on the electrical path from the second battery to the first battery.

For example, the at least one switch may include a transfer switch adjacent to the driving motor, and an additional switch between the second battery and the transfer switch. For example, the transfer switch may include one or more switches for switching battery operating modes. For example, the additional switch may operate to block the current output from the second battery. For example, the control device 140 may block, based on the operating state of the additional switch, the current flowing from the second battery to the first battery, thereby preventing conflicts between currents output from different batteries.

For example, the capacitor may be initially charged based on the current output from the second battery.

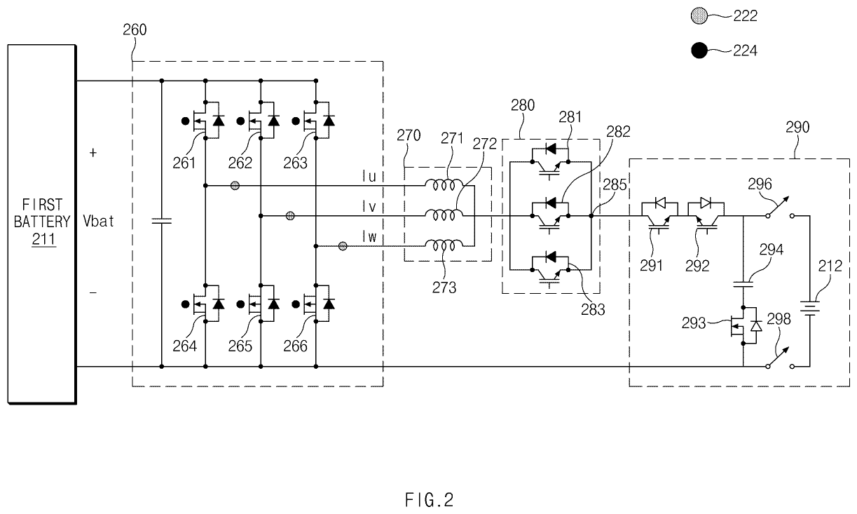

According to an embodiment, the sensor device 220 may include at least one sensor that obtains (or identifies) a real-time status of at least part of components of the host vehicle. For example, the sensor device 220 can be a current sensor (222 in FIG. 2) and/or a temperature sensor (224 in FIG. 2).

For example, the sensor device 220 may include at least one of a current sensor, a temperature sensor, or a battery sensor, or any combination thereof.

For example, the control device 140 may identify, based on the sensor device 220, information about the operating performance (e.g., at least one of a current, a voltage, or a temperature, or any combination thereof) of various components electrically connected to the battery 110 in real time.

For example, the control device 140 may identify, based on the sensor device 220, the real-time status (e.g., state-of-charge (SoC), a temperature, or real-time performance) of the battery 110.

According to an embodiment, the memory 130 (storage medium) may store instructions or data. For example, the memory 130 may store one or more instructions that cause the vehicle control apparatus 100 to perform various operations if executed by the control device 140.

For example, the memory 130 and the control device 140 may be implemented as one chipset. The control device 140 may include at least one of a communication processor and/or a modem.

According to an embodiment, the control device 140 (e.g., controller) may be operatively connected to at least one of the battery 110, the driving device 120, the memory 130, or any combination thereof. For example, the control device 140 may control an operation of at least one of the battery 110, the driving device 120, the memory 130, or any combination thereof.

For example, the control device 140 may drive the driving motor, based on the first battery (or the main battery) included in the battery 110.

For example, before a trigger signal described below is identified, the control device 140 may block, based on the additional switch operatively connected to the second battery, the current output from the second battery. In this way, while performing, based on only the first battery, driving control, the control device 140 may prevent an imbalance due to the current output from the second battery, thereby performing stable and efficient battery control.

For example, while performing driving control of the host vehicle through the driving motor, the control device 140 may identify the trigger signal regarding ODC using the second battery. If the trigger signal is identified, the control device 140 may charge, based on the second battery, the first battery.

For example, the control device 140 may identify, based on the sensor device 220, the first SoC and second SoC of the first battery. If the ratio between first SoC and second SoC is outside the specified range, the control device 140 may determine that the trigger signal is identified. For example, the control device 140 may determine that the trigger signal is identified, if the difference between the first SoC and the second SoC exceeds the specified value. For example, if the first SoC is 80% and the second SoC is 70% to 90%, the control device 140 may determine that a ratio between the first SoC and the second SoC does not exceed the specified range. These numbers are illustrative and embodiments of the present disclosure are not limited thereto.

For example, if the trigger signal is identified, the control device 140 may change an operating state of the additional switch, and may charge, based on the current output from the second battery, the first battery.

For example, the control device 140 may identify (or measure), based on the sensor device 220, information about three-phase currents of the driving motor.

For example, the control device 140 may identify (or measure), based on the sensor device 220, the mean value of the three-phase currents, and the neutral current of the transfer switch placed in an electrical path between the driving motor and the second battery. For example, the neutral current may be substantially the same current as the current output from the second battery.

For example, the control device 140 may identify (or measure), based on the sensor device 220, a difference between the maximum value and the minimum value of each of the three-phase currents included in the driving motor. For example, if only the mean value is not the same as the neutral current, the control device 140 may identify (or measure), based on the sensor device 220, a difference between the maximum value and the minimum value of each of three-phase currents included in the driving motor.

For example, the control device 140 may apply, based on the measured difference and the mean value, duty compensation to an element corresponding to one of three-phase currents.

For example, the control device 140 may identify the greatest value among differences between the maximum value and minimum value of each of the three-phase currents, and may compare the greatest value with another difference. For example, it may be assumed that a phase corresponding to the greatest value is the third phase. In other words, assuming that the greatest value is the difference between a third maximum value and a third minimum value of the third phase, the control device 140 may compare the third difference with a first difference between a first maximum value and a second minimum value of the first phase current, for example.

For example, if the third difference is identified as being greater than or equal to the first difference, the control device 140 may determine that compensation for the first phase is necessary because an imbalance occurs in the first phase current. Accordingly, the control device 140 may apply duty compensation to a first element corresponding to the first phase. For example, the first element may include a first switch module that corresponds to the first phase and is placed on an electrical path between the first battery and the driving motor.

For example, the control device 140 may calculate the duty compensation in proportion to the magnitude of the difference between the first difference and the third difference (or, the greatest value).

For example, the control device 140 may increase, based on applying the duty compensation to the first element, the operating time of the first element. In this way, the on-state duration of the first element may increase, and the magnitude of the current flowing in the first phase may increase. Accordingly, the compensation voltage corresponding to the first phase may be applied.

The component of the vehicle control apparatus 100 shown in FIG. 1 is an example, and embodiments of the present disclosure are not limited thereto. For example, the vehicle control apparatus 100 may further include at least one of a driving device, an input device, a communication device, or an interface device, or any combination thereof.

According to an embodiment, the driving device may include at least one driving device that operates to control driving of the host vehicle.

For example, the driving device may include at least one driving motor. For example, the control device 140 may drive, based on power from the battery 110, at least one driving motor included in the driving device.

For example, the driving motor may be electrically connected to the first battery through an inverter.

For example, the driving motor may be electrically connected to the second battery through a transfer switch, an additional switch, and at least one relay.

FIG. 2 is a circuit diagram showing components of a vehicle control apparatus, according to an embodiment of the present disclosure.

According to an embodiment, a vehicle control apparatus (e.g., the vehicle control apparatus 100 of FIG. 1) may include a first battery 211, a second battery 212, a current sensor 222, a temperature sensor 224, an inverter 260, a driving motor 270, a transfer switch 280, and a charging module 290, any combination of or all of which may be in plural or may include plural components thereof.

For example, the first battery 211 (or a main battery) may be a main battery for driving the driving motor 270. The second battery 212 may be an auxiliary battery for charging the first battery 211.

For example, the first battery 211 may be electrically connected to the driving motor 270 through the inverter 260.

For example, the inverter 260 may include at least one switch 261, 262, 263, 264, 265, and 266 that open and close electrical paths between the driving motor 270 and three phases of the first battery 211.

For example, the first switch 261 and the fourth switch 264 may open and close an electrical path for a first phase 271 of the driving motor 270.

For example, the second switch 262 and the fifth switch 265 may open and close an electrical path for a second phase 272 of the driving motor 270.

For example, the third switch 263 and the sixth switch 266 may open and close an electrical path for a third phase 273 of the driving motor 270.

For example, the driving motor 270 may be electrically connected to the charging module 290 through the transfer switch 280.

For example, Iᵤ in FIG. 2 may be a current flowing into the first phase 271 of the driving motor.

For example, Iᵥ in FIG. 2 may be a current flowing into the second phase 272 of the driving motor.

For example, I_{w} in FIG. 2 may be a current flowing into the third phase 273 of the driving motor.

For example, the transfer switch 280 may include switches 281, 282, and 283 provided for switching a battery operation mode.

For example, the vehicle control apparatus may monitor the neutral current of the transfer switch 280. For example, the neutral current of the transfer switch 280 may be a current flowing at a specified point 285 where electrical paths flowing from the first transfer switch 281, the second transfer switch 282, and the third transfer switch 283 meet each other.

For example, the charging module 290 may include a plurality of components provided for charging the first battery 211.

For example, the charging module 290 may include a first additional switch 291, a second additional switch 292, a third additional switch 293, a capacitor 294, a first relay 296, and a second relay 298, any combination of or all of which may be in plural or may include plural components thereof. For example, the vehicle control apparatus may deliver a current output from the second battery 212 to the first battery 211 through the charging module 290 based on operating states of the first additional switch 291, the second additional switch 292, the third additional switch 293, the first relay 296, and the second relay 298.

For example, the charging module 290 may include the second battery 212 (or an auxiliary battery). The second battery 212 may store power for charging the first battery 211. The vehicle control apparatus may determine whether to perform a charging operation of the first battery 211 through the second battery 212, based on whether a ratio between a first SoC of the first battery 211 and a second SoC of the second battery 212 is outside a specified range (or whether a trigger signal regarding ODC is identified).

The driving devices shown in FIG. 2 are examples, and the vehicle control apparatus may further include other components not shown.

For example, the vehicle control apparatus may further include at least one of a third battery (not shown), or a second inverter (not shown), or any combination thereof.

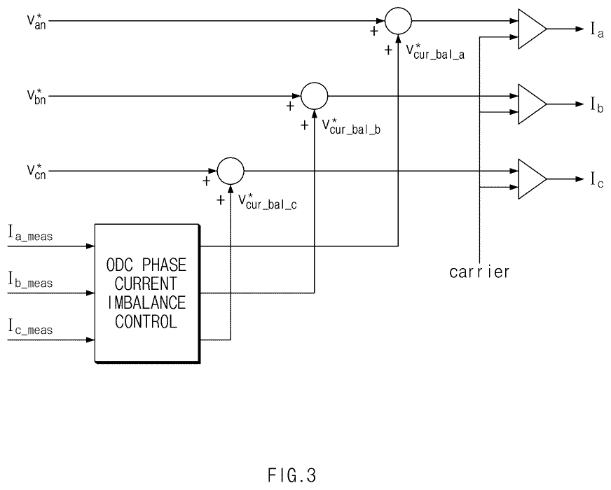

FIG. 3 is a diagram conceptually illustrating a circuit diagram illustrating an algorithm, in which a vehicle control apparatus applies duty compensation, according to an embodiment of the present disclosure.

According to an embodiment, a vehicle control apparatus (e.g., the vehicle control apparatus 100 of FIG. 1) may measure three-phase currents for a driving motor.

For example, in a situation where the vehicle control apparatus charges, based an auxiliary battery, a main battery while a host vehicle is driving, the vehicle control apparatus may measure the three-phase currents for the driving motor.

For example, the vehicle control apparatus may measure, based on a sensor device (e.g., the sensor device 220 in FIG. 1), a first phase current L_{a_meas} flowing into a first phase.

For example, the vehicle control apparatus may measure, based on the sensor device, a second phase current I_{b_meas} flowing into a second phase.

For example, the vehicle control apparatus may measure, based on the sensor device, a third phase current I_{c_meas} flowing into a third phase.

For example, the vehicle control apparatus may compare a mean value of the three-phase currents with the neutral current of a transfer switch (e.g., the transfer switch 280 in FIG. 2). If the mean value is not the same as the neutral current, the vehicle control apparatus may apply duty compensation to a specific phase based on ODC phase current imbalance control. Due to the compensation voltage generated based on applying the duty compensation, three-phase imbalance may be improved.

For example, the vehicle control apparatus may measure a difference between the maximum value and minimum value of each of three-phase currents.

For example, the vehicle control apparatus may compare the greatest value among the measured differences with a difference between the maximum value and the minimum value of a current of a specific phase.

For example, if the greatest value among the measured differences is identified as being greater than or equal to a first difference between the first maximum value and the second minimum value of the first phase current I_{a_meas}, the vehicle control apparatus may increase, based on applying duty compensation to the first element corresponding to the first phase through which the first phase current I_{a_meas} flows, the on-operating time of a first element (e.g., the first switch 261 in FIG. 2). In this way, compensation voltage V*_{cur_bal_a} may additionally occur at voltage V*ₐₙ before the duty compensation is applied to the first phase.

For example, if the greatest value among the measured differences is identified as being greater than or equal to a second difference between the second maximum value and the second minimum value of the second phase current I_{b_meas}, the vehicle control apparatus may increase, based on applying duty compensation to the second element corresponding to the second phase through which the second phase current I_{b_meas} flows, the on-operating time of a second element (e.g., the second switch 262 in FIG. 2). In this way, compensation voltage V*_{cur_bal_b} may additionally occur at voltage V*_{bn} before the duty compensation is applied to the second phase.

For example, if the greatest value among the measured differences is identified as being greater than or equal to a third difference between the third maximum value and the third minimum value of the third phase current I_{c_meas}, the vehicle control apparatus may increase, based on applying duty compensation to the third element corresponding to the third phase through which the third phase current I_{c_meas} flows, the on-operating time of a third element (e.g., the third switch 263 in FIG. 2). In this way, compensation voltage V*_{cur_bal_c} may additionally occur at voltage V*_{cn} before the duty compensation is applied to the third phase.

On the basis of the duty compensation algorithm described above, the driving motor may operate based on a first phase compensation current Iₐ, a second phase compensation current I_{b}, and a third phase compensation current I_{c}.

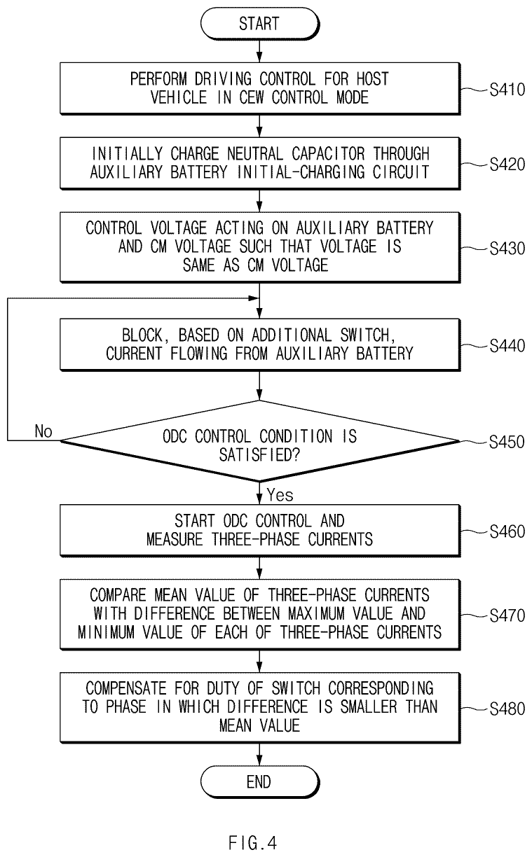

FIG. 4 is a flowchart of a vehicle control method, according to an embodiment of the present disclosure.

According to an embodiment, a vehicle control apparatus (e.g., the vehicle control apparatus 100 of FIG. 1) may perform operations described in FIG. 4. For example, at least some of components (e.g., the battery 110, the driving device 120, the memory 130, and the control device 140 in FIG. 1) included in the vehicle control apparatus may be set to perform operations of FIG. 4.

In the following embodiment, operations S410 to S480 may be sequentially performed, but are not always performed sequentially. For example, the order of operations may be changed, and at least two operations may be performed in parallel. Moreover, descriptions corresponding to or identical to the above-mentioned descriptions given with reference to FIG. 4 may be briefly described or omitted to avoid redundancy.

According to an embodiment, the vehicle control apparatus may perform driving control for a host vehicle in close-end winding (CEW) control mode (operation S410).

For example, the CEW control mode may be a control mode that drives, based on operating only a main battery (e.g., the first battery 211 in FIG. 2), a driving motor (e.g., the driving motor 270 in FIG. 2).

For example, in the CEW control mode, an inverter (e.g., the inverter 260 in FIG. 2) connected to the main battery may transmit a driving signal based on a specified pulse width modulation (PWM) control technique (e.g., RSPWM or Random Switching PWM) to a driving device.

According to an embodiment, the vehicle control apparatus may initially charge a neutral capacitor through the auxiliary battery initial-charging circuit (operation S420).

For example, in a process of preparing to charge the main battery using an auxiliary battery (e.g., the second battery 212 in FIG. 2), the vehicle control apparatus may initially charge the neutral capacitor (e.g., the capacitor 294 in FIG. 2) through an initial-charging circuit (e.g., at least part of the circuit of the charging module 290 in FIG. 2).

For example, the vehicle control apparatus may initially charge the neutral capacitor by a specified ratio (e.g., 50%) of the capacity of the main battery.

According to an embodiment, the vehicle control apparatus may control the voltage acting on the auxiliary battery and a CM voltage (e.g., a common-mode voltage) such that the voltage is the same as the CM voltage (operation S430).

For example, the vehicle control apparatus may set the voltage acting on the auxiliary battery and the CM voltage (e.g., a common-mode voltage) such that the voltage is the same as the CM voltage, based on the inverter (e.g., the inverter 260 in FIG. 2) and/or the specified PWM control technique (e.g., RSPWM or Random Switching PWM).

According to an embodiment, the vehicle control apparatus may block, based on an additional switch, the current flowing from the auxiliary battery (operation S440).

For example, the vehicle control apparatus may control, based on setting an operating state of the additional switch to a specified state (e.g., On), current so as to prevent the current from flowing from the auxiliary battery to the main battery.

According to an embodiment, the vehicle control apparatus may determine whether an ODC control condition is satisfied (operation S450).

For example, if the ratio between a first SoC and a second SoC is outside a specified range, the vehicle control apparatus may identify that the ODC control condition is satisfied.

For example, if the difference between the first SoC and the second SoC exceeds a specified value, the vehicle control apparatus may identify that the ODC control condition is satisfied.

For example, if the ODC control condition is satisfied (e.g., operation S450=Yes), the autonomous driving control apparatus may perform operation S460.

For example, if the ODC control condition is not satisfied (e.g., operation S450=No), the autonomous driving control apparatus may repeat operation S440.

According to an embodiment, the vehicle control apparatus may start ODC control and may measure three-phase currents (operation S460).

For example, while the host vehicle is driving based on the driving device through the current output from the first battery, the vehicle control apparatus may perform, based on the second battery, the ODC control for charging the first battery.

For example, the vehicle control apparatus may measure the three-phase currents of a driving motor.

According to an embodiment, the vehicle control apparatus may compare a mean value of the three-phase currents with a difference between the maximum value and the minimum value of each of the three-phase currents (operation S470).

For example, if or only if the mean value of the three-phase currents is not the same as the neutral current of the transfer switch, the vehicle control apparatus may measure the difference between the maximum value and minimum value of each three-phase current.

According to an embodiment, the vehicle control apparatus may compensate for the duty of a switch corresponding to a phase in which the difference is smaller than the mean value (operation S480).

For example, if the greatest value of the differences is identified as being greater than or equal to a first difference between a first maximum value and a second minimum value of the first phase current, the vehicle control apparatus may apply duty compensation to a switch (e.g., the first switch 261 in FIG. 2) corresponding to the first phase through which the first phase current flows.

For example, after applying the duty compensation to the switch corresponding to the first phase, the vehicle control apparatus may determine, based on comparing the greatest value of the differences with a difference between the maximum value and the minimum value of each current of the second phase and the third phase, whether to apply duty compensation.

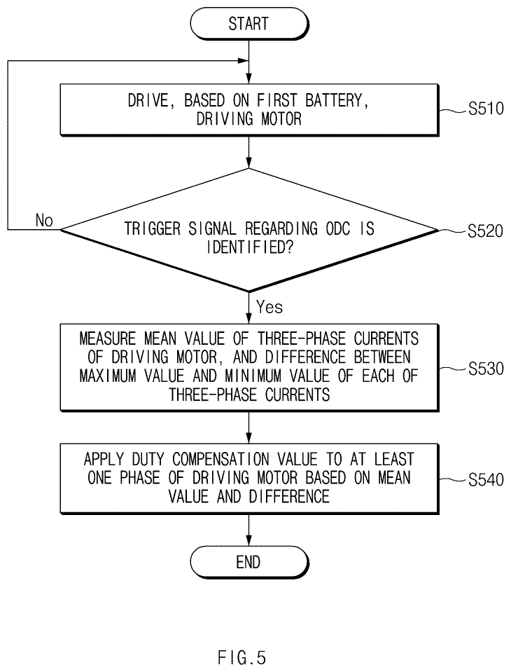

FIG. 5 is a flowchart of a vehicle control method, according to an embodiment of the present disclosure.

According to an embodiment, a vehicle control apparatus (e.g., the vehicle control apparatus 100 of FIG. 1) may perform operations described in FIG. 5. For example, at least some of components (e.g., the battery 110, the driving device 120, the memory 130, and the control device 140 in FIG. 1) included in the vehicle control apparatus may be set to perform operations of FIG. 5.

In the following embodiment, operations S510 to S540 may be sequentially performed, but are not always performed sequentially. For example, the order of operations may be changed, and at least two operations may be performed in parallel. Moreover, descriptions corresponding to or identical to the above-mentioned descriptions given with reference to FIG. 5 may be briefly described or omitted to avoid redundancy.

According to an embodiment, the vehicle control apparatus may drive, based on a first battery, a driving motor (operation S510).

According to an embodiment, the vehicle control apparatus may identify a trigger signal regarding ODC (operation S520).

For example, if a ratio between the first SoC and the second SoC is outside a specified range, the vehicle control apparatus may determine that the trigger signal is identified.

For example, if a difference between the first SoC and the second SoC exceeds a specified value, the vehicle control apparatus may determine that a trigger signal is identified.

For example, if the trigger signal regarding ODC is identified (e.g., operation S520=Yes), an autonomous driving control apparatus may perform operation S530.

For example, if the trigger signal regarding ODC is not identified (e.g., operation S520=No), the autonomous driving control apparatus may repeat operation S510.

According to an embodiment, the vehicle control apparatus may measure a mean value of three-phase currents of a driving motor, and a difference between the maximum value and the minimum value of the three-phase currents (operation S530).

According to an embodiment, the vehicle control apparatus may apply a duty compensation value to at least one phase of the driving motor based on the mean value and the difference (operation S540).

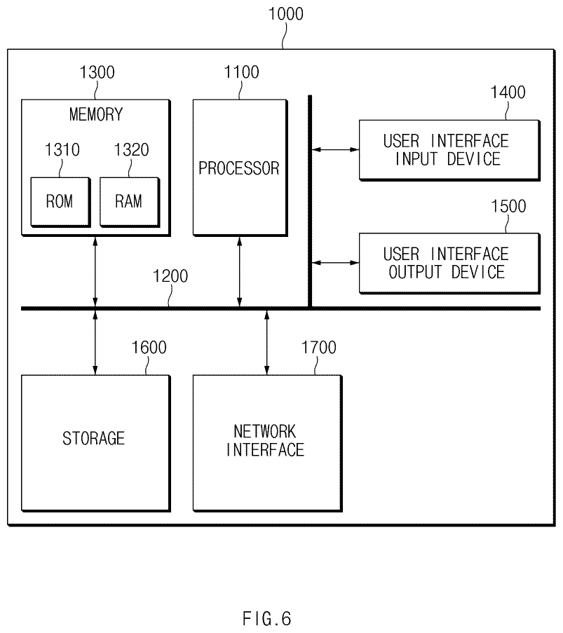

FIG. 6 shows a computing system related to a vehicle control apparatus or vehicle control method, according to an embodiment of the present disclosure.

Referring to FIG. 6, a computing system 1000 related to a vehicle control apparatus or a vehicle control method may include at least one processor 1100, a memory 1300, a user interface input device 1400, a user interface output device 1500, a storage 1600, and a network interface 1700, which can be connected with each other via a bus 1200, any combination of or all of which may be in plural or may include plural components thereof.

The processor 1100 may be a central processing unit (CPU) or a semiconductor device that processes instructions stored in a storage medium, which can include the memory 1300 and/or the storage 1600. Each of the memory 1300 and the storage 1600 may include various types of volatile or nonvolatile storage media. For example, the memory 1300 may include a read only memory (ROM) and a random access memory (RAM).

Accordingly, the operations of the method or algorithm described in connection with the embodiments disclosed in the specification may be directly implemented with a hardware module, a software module, or a combination of the hardware module and the software module, which is executed by the processor 1100. The software module may reside on a storage medium (i.e., the memory 1300 and/or the storage 1600) such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal. One or more processors for the processor 1100 can be together and/or separated/remote.

The above description is merely example embodiments of the present disclosure, and various modifications and modifications may be made by one skilled in the art without departing from the scopes of the present disclosure.

Accordingly, example embodiments of the present disclosure are intended not to limit but to explain technical ideas of the present disclosure, and scopes and spirit of the present disclosure are not necessarily limited by the example embodiments. Scopes of protection of the present disclosure can be construed by the attached claims, and all equivalents thereof can be construed as being included within scopes of the present disclosure.

Some embodiments of the present disclosure can provide a vehicle control apparatus that controls a phase-current imbalance to be minimized while charging a first battery, based on a second battery (e.g., an auxiliary battery), if a trigger signal is identified while driving a driving motor, based on the first battery (e.g., the main battery).

Some embodiments of the present disclosure can provide a vehicle control apparatus that applies, to at least one element (e.g., a switch), the duty compensation calculated based on a mean value of three-phase currents acting on the driving motor, and a comparison result between the maximum value and the minimum value of each of three-phase currents.

Some embodiments of the present disclosure can provide a vehicle control apparatus that increases, based on applying duty compensation to at least one switch, an operating time of a switch and generates a compensation voltage, and increases the magnitude of a current in a phase corresponding to the corresponding switch among three-phase currents.

Some embodiments of the present disclosure can provide a vehicle control apparatus that blocks, based on an additional switch, a current output from a second battery before a trigger signal is identified, thereby preventing a conflict between currents output from the first and second batteries.

Although the present disclosure was described with reference to example embodiments and the accompanying drawings, the present disclosure is not necessarily limited thereto, but may be variously modified and altered by those skilled in the art to which the present disclosure pertains without departing from the spirit and scopes of the present disclosure claimed in the following claims.

What is claimed is:

1. A vehicle control apparatus comprising:
a first battery:
a second battery;
a sensor device;
a memory configured to store instructions; and
a control device operatively connected to the first battery, the second battery, the sensor device, and the memory,
wherein the instructions, when executed by the control device, enable the control device to cause the vehicle control apparatus to:
drive a driving motor using the first battery;
charge the first battery using the second battery, if identifying a trigger signal regarding on-drive-charge (ODC) using the second battery while performing driving control of a host vehicle through the driving motor;
measure, using the sensor device, a mean value of three-phase currents, and a swing difference between a maximum value and a minimum value of each of the three-phase currents of the driving motor; and
apply duty compensation to an element corresponding to at least one of the three-phase currents based on the swing difference and the mean value.

2. The vehicle control apparatus of claim 1, wherein the instructions, when executed by the control device, further enable the control device to cause the vehicle control apparatus to
block, based on an additional switch operatively connected to the second battery, a current output from the second battery before identifying the trigger signal.

3. The vehicle control apparatus of claim 1, wherein the instructions, when executed by the control device, further enable the control device to cause the vehicle control apparatus to:
identify, based on the sensor device, a first state of charge (SoC) of the first battery and a second SoC of the second battery; and
determine that the trigger signal is identified, if a ratio between the first SoC and the second SoC is outside a specified range.

4. The vehicle control apparatus of claim 1, wherein the instructions, when executed by the control device, further enable the control device to cause the vehicle control apparatus to:
compare, based on the sensor device, the mean value of the three-phase currents with a neutral current of a transfer switch in a second electrical path between the driving motor and the second battery; and
measure the swing difference between the maximum value and the minimum value of each of the three-phase currents if the mean value is not equal to the neutral current.

5. The vehicle control apparatus of claim 4, wherein the instructions, when executed by the control device, further enable the control device to cause the vehicle control apparatus to
apply the duty compensation to a first element corresponding to a first phase, through which a first phase current flows, if a greatest value of the swing difference is identified as being greater than or equal to a first difference between a first maximum value and a second minimum value of the first phase current.

6. The vehicle control apparatus of claim 5, wherein the first element includes a first switch module corresponding to the first phase and in a first electrical path between the first battery and the driving motor.

7. The vehicle control apparatus of claim 5, wherein the instructions, when executed by the control device, further enable the control device to cause the vehicle control apparatus to
determine the duty compensation to be proportional to a magnitude of a delta difference between the first difference and the greatest value.

8. The vehicle control apparatus of claim 5, wherein the instructions, when executed by the control device, further enable the control device to cause the vehicle control apparatus to
increase, based on applying the duty compensation to the first element, an operating time of the first element.

9. A vehicle control method, the method comprising:
driving a driving motor using a first battery;
charging the first battery using a second battery if identifying a trigger signal regarding on-drive-charge (ODC) using the second battery while performing driving control of a host vehicle through the driving motor;
measuring a mean value of three-phase currents;
measuring a swing difference between a maximum value and a minimum value of each of the three-phase currents of the driving motor; and
applying duty compensation to an element corresponding to at least one of the three-phase currents based on the swing difference and the mean value.

10. The method of claim 9, further comprising blocking a current output from the second battery, using an additional switch operatively connected to the second battery, before identifying the trigger signal.

11. The method of claim 9, further comprising:
identifying a first state of charge (SoC) of the first battery;
identifying a second SoC of the second battery; and
determining that the trigger signal is identified, if a ratio between the first SoC and the second SoC is outside a specified range.

12. The method of claim 9, further comprising:
comparing the mean value of the three-phase currents, with a neutral current of a transfer switch in a second electrical path between the driving motor and the second battery; and
measuring the swing difference between the maximum value and the minimum value of each of the three-phase currents if the mean value is not equal to the neutral current.

13. The method of claim 12, further comprising applying the duty compensation to a first element corresponding to a first phase, through which a first phase current flows, if a greatest value of the swing difference is identified as being greater than or equal to a first difference between a first maximum value and a second minimum value of the first phase current.

14. The method of claim 13, wherein the first element includes a first switch module corresponding to the first phase and in a first electrical path between the first battery and the driving motor.

15. The method of claim 13, further comprising determining the duty compensation to be proportional to a magnitude of a delta difference between the first difference and the greatest value.

16. A computer-readable recording medium including a program for executing a vehicle control method, wherein the vehicle control method comprises:
driving, based on a first battery, a driving motor by a control device;
charging, based on a second battery, the first battery by the control device if identifying a trigger signal regarding on-drive-charge (ODC) using the second battery while performing driving control of a host vehicle through the driving motor;
measuring, based on a sensor device, a mean value of three-phase currents;
measuring, based on the sensor device, a swing difference between a maximum value and a minimum value of each of the three-phase currents of the driving motor by the control device; and
applying, by the control device, duty compensation to an element corresponding to at least one of the three-phase currents based on the swing difference and the mean value.

17. The computer-readable recording medium of claim 16, wherein the vehicle control method further comprises blocking, based on an additional switch operatively connected to the second battery, a current output from the second battery by the control device before identifying the trigger signal.

18. The computer-readable recording medium of claim 16, wherein the vehicle control method further comprises:
identifying, based on the sensor device, a first state of charge (SoC) of the first battery by the control device;
identifying, based on the sensor device, a second SoC of the second battery by the control device; and
determining, by the control device, that the trigger signal is identified, if a ratio between the first SoC and the second SoC is outside a specified range.

19. The computer-readable recording medium of claim 18, wherein the vehicle control method further comprises:
comparing, based on the sensor device, the mean value of the three-phase currents, with a neutral current of a transfer switch placed in an electrical path between the driving motor and the second battery by the control device; and
measuring, by the control device, the swing difference between the maximum value and the minimum value of each of the three-phase currents if the mean value is not equal to the neutral current.

20. The computer-readable recording medium of claim 19, wherein the vehicle control method further comprises applying, by the control device, the duty compensation to a first element corresponding to a first phase, through which a first phase current flows, if a greatest value of the swing difference is identified as being greater than or equal to a first difference between a first maximum value and a second minimum value of the first phase current.
